(19) United States
(12) Patent Application Publication
(10) Pub. No.: US 2004/0104792 A1
(43) Pub. Date: Jun. 3, 2004

(54) Open loop resonator filter using aperture

(76) Inventors: Young Wan Kim, Daejon (KR); Byung Su Kang, Daejon (KR); Nae-soo Kim, Daejon (KR); Deock Gil Oh, Daejon (KR); Chul Hen Seo, Seoul (KR); Serk Soon Im, Incheon (KR); Jae Hoon Kim, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/452,863

(22) Filed: Jun. 2, 2003

(30) Foreign Application Priority Data
Nov. 30, 2002 (KR) 2002-75685

(51) Int. Cl. H01P 1/203

(52) U.S. Cl. 333/204; 333/219.1

(57) ABSTRACT

An open loop resonator filter employed aperture on the ground plane is disclosed. The open loop resonator filter using apertures on the ground plane formed on the dielectric substrate, the open loop resonator filter including: one or more open loop resonators formed on a upper side of the dielectric substrate and implemented by microstrip lines; and one or more apertures formed on a predetermined area of the ground plane. The present invention can control the coupling coefficient of the open loop resonator without degrading the group delay characteristics by forming the aperture on the ground plane. Therefore, by forming the aperture on the ground plane, it is possible to design a filter having a wide bandwidth characteristic.

### FIELD OF THE INVENTION

The present invention relates to an open loop resonator filter using an aperture on the ground plane; and, more particularly, to an open loop resonator filter with an aperture providing the wide bandwidth and high selectivity characteristics for high-speed data transmission system.

### DESCRIPTION OF THE RELATED ARTS

In modern communication system, a filter for a radio frequency (RF) or an intermediate frequency (IF) has been required to be small, to be easily fabricated, to have flat group delay and especially, wide bandwidth because of high-speed data rate.

Although a surface acoustic wave (SAW) filter has been widely used because of its recognizable selectivity. However, the SAW filter is not applicable to broadband system for bad group delay ripple and narrow bandwidth. Thus, it is too difficult to implement the SAW filter into the high-speed communication system that requires wide bandwidth.

In a meantime, a filter using a microstrip is easy to be manufactured and easy to be miniaturized. Therefore, there are many studies progressed for developing the filter using microstrip in various forms. However, in case the conventional half wavelength type resonator is used for the filter, there is a problem for miniaturization of the filter since multiple layers of the resonator are necessary for high selectivity, small insertion loss and flat group delay characteristics.

For overcoming abovementioned problem, a half wavelength open loop resonator has been used for a small filter fabrication in fields of narrowband communication circuit, especially a mobile communication. However, there is no study been progressed for wideband communication application like a high-speed satellite communication.

Generally, the wide bandwidth of the open loop resonator filter can be obtained by tight coupling between loops which mean higher coupling coefficient. It is possible by reducing a coupling gap between loops and thickness of microstrip line.

However, the pass-band ripple also is large because the difference between two resonant frequencies due to tight coupling is large. Also, there is a limitation on reducing coupling space between loops for tight coupling.

In case the coupling space between loops is extremely narrow, the sensitivity of the filter can become serious problem and it is difficult to fabricate the filter.

For broadening of the filter bandwidth, the aperture is employed on the ground of the coupled line in open loop resonator filter.

FIGS. 1A and 1B are a diagram for explaining magnetic coupling of an open loop resonator employing aperture. A circuit of FIG. 1B is an equivalent circuit of FIG. 1A.

In conventional open loop resonator filter structure, the wider bandwidth is achieved by decreasing the coupling gap d. As referring FIGS. 1A and 1B, the difference between two resonance frequencies become wider by increasing the aperture width w. Therefore, the effect of the increased aperture width w is same as that of the decreased coupling space d of the conventional structure with no aperture.

A coupling coefficient and resonance frequency of the open loop resonator with magnetic coupling of FIG. 1A can be expressed as following equations 1 and 2.

$$\begin{matrix}{f}_{m} = \frac{1}{2 π fC ( L - {L}_{m} )} , {f}_{e} = \frac{1}{2 π fC ( L + {L}_{m} )} & Eq . 1 \\ {K}_{E} = \frac{{L}_{m}}{L} & Eq . 2\end{matrix}$$

In Eqs. 1 and 2, C represents a self-capacitance and L is a self-inductance. Lₘ is a mutual inductance.

Similar equations of Eqs. 1 and 2 are implemented for electric coupling and electro-magnetic coupling. Among the coupling methods, a coupling method having the biggest difference between two resonance frequencies is the magnetic coupling. That is, the bandwidth can be mainly controlled by coupling coefficient of the magnetic coupling.

On the other hand, if the coupling gap between two open loop resonators is narrower, which is a case of FIG. 1A without an aperture, then the mutual inductance Lₘ is increased and the difference between two resonance frequencies fₑ and fₘ is also increased.

However, in case of reducing the coupling gap between lines and thickness of line in the above mentioned conventional open loop resonator, it causes to increase a ripple of the pass-band. Also, if the gap becomes extremely narrowed, manufacturing process of a circuit will be very complicated because of a responsiveness of manufacturing.

### SUMMARY OF THE INVENTION

It is, therefore, an object of the present invention to provide a small size open loop resonator filter structure with wide bandwidth, flat group delay and superior selectivity characteristics by forming an aperture on a predetermined portion of a ground plane.

In accordance with an aspect of the present invention, there is provided an open loop resonator filter employed aperture on the ground plane, the open loop resonator filter including: one or more open loop resonators formed on a upper side of the dielectric substrate and implemented by microstrip lines; and one or more apertures on a predetermined area of the ground plane.

### BRIEF DESCRIPTION OF THE DRAWING(S)

The above and other objects and features of the present invention will become apparent from the following description of the preferred embodiments given in conjunction with the accompanying drawings, in which:

FIGS. 1A and 1B are a diagram for explaining magnetic coupling of an open loop resonator using an aperture on the ground plane;

FIG. 2 is a perspective view of an open loop resonator filter using an aperture in accordance with a preferred embodiment of the present invention;

FIG. 3A is a upper side view of an open loop resonator filter using aperture in accordance with another preferred embodiment of the present invention;

FIG. 3B is a rear view forming aperture of the FIG. 3A;

FIG. 4 is graph for explaining the amplitude transfer characteristics of the open loop resonator filter of FIG. 3; and

FIG. 5 is a graph for explaining the group delay characteristics of the open loop resonator filter in FIG. 3.

### DETAILED DESCRIPTION OF THE INVENTION

Other objects and aspects of the invention will become apparent from the following description of the embodiments with reference to the accompanying drawings, which is set forth hereinafter.

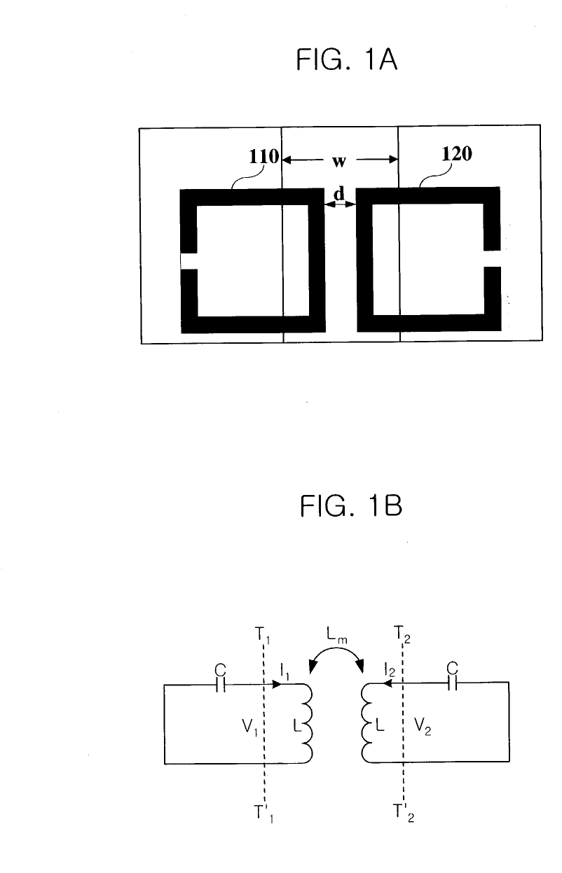

FIGS. 1A and 1B are a diagram for explaining magnetic coupling of an open loop resonator using an aperture. A circuit of FIG. 1B is an equivalent circuit of FIG. 1A.

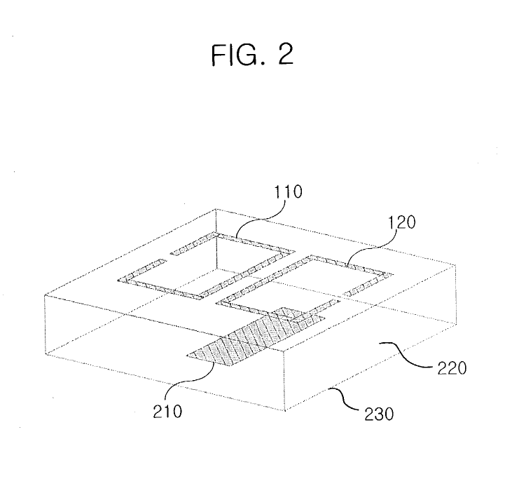

FIG. 2 is a perspective view of an open loop resonator filter using an aperture in accordance with a preferred embodiment of the present invention.

As referring to FIG. 2, the open loop resonator filter includes open loop resonators 110 and 120, an aperture 210, a dielectric substrate 220 and a ground plane 230.

The open loop resonators 110 and 120 are formed by microstrip lines.

The aperture 210 is formed on a predetermined position of the ground plane 230 and the predetermined position is a downwardly projected position from a position of an upper side where two resonators are faced and a gap coupling is occurred.

According to the present invention, the bandwidth of the filter can be controlled by width of the aperture 210 without changing a coupling gap d of the open loop resonators 110 and 120.

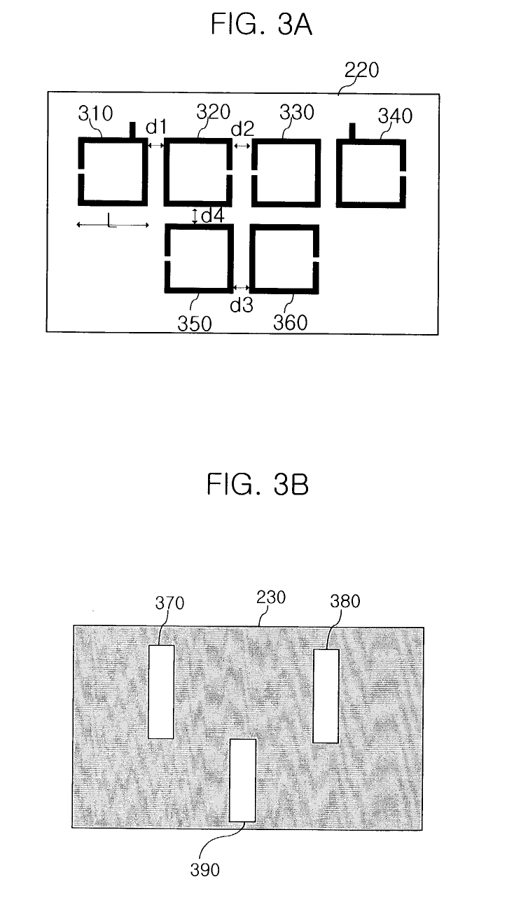

FIG. 3A is a perspective view of an open loop resonator filter using an aperture in accordance with another preferred embodiment of the present invention. The open loop resonator filter of FIG. 3A has 6 poles and FIG. 3B is a rear view of the FIG. 3A.

Referring to FIGS. 3A and 3B, the open loop resonator includes a plurality of open loop resonators 310 to 360, a plurality of aperture 370, 380 and 390, a dielectric substrate 220 and a ground plane 230.

The aperture 370, 380 and 390 are used for coupling each of open loop resonators 310 and 320, 330 and 340, and 350 and 360.

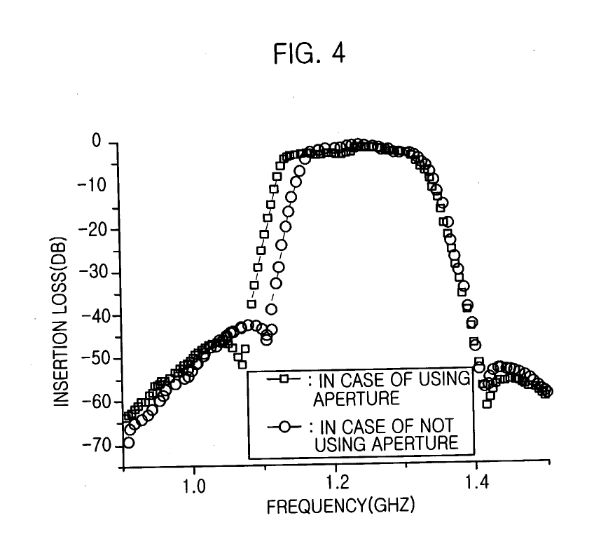

FIG. 4 is a graph for explaining the amplitude transfer characteristics of the open loop resonator filter of FIG. 3. The open loop resonator filter of the present invention is compared with a conventional open loop resonator filter without the aperture.

For accurate comparison, two filters have same condition such as a length of open loops L and gap d between loops. Only difference of two filters is implementation of the aperture.

As shown in FIG. 4, the bandwidth of the filter with aperture is increased by 25% comparing to the filter with no aperture.

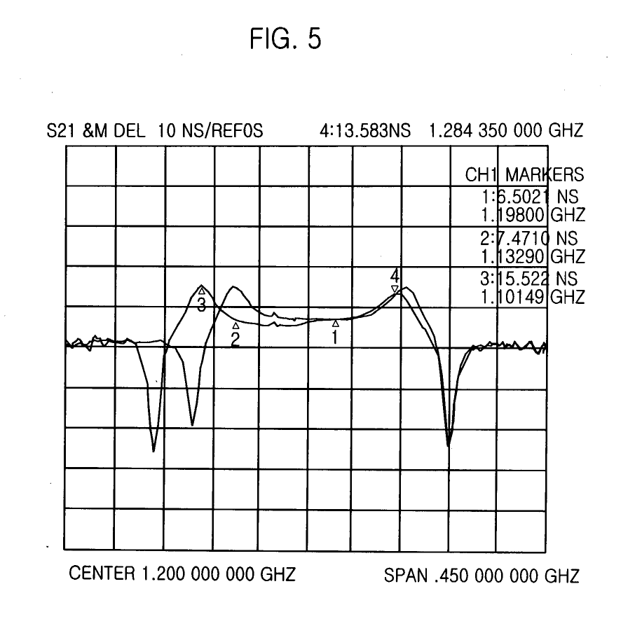

FIG. 5 is a graph for explaining a group delay characteristics of the open loop resonator filter in FIG. 3. The open loop resonator filter of the present invention is compared with an open loop resonator filter without the aperture.

Referring to FIG. 5, the open loop resonator filter of the present invention does not degrade the group delay characteristics comparing to the filter without the aperture.

As mentioned above, the present invention can control the coupling coefficient of the open loop resonator without degrading the group delay characteristics by forming the aperture on the ground plane. Therefore, by forming the aperture on the ground plane, it is possible to design a filter having a wide bandwidth characteristic.

While the present invention has been described with respect to certain preferred embodiments, it will be apparent to those skilled in the art that various changes and modifications may be made without departing from the scope of the invention as defined in the following claims.

What is claimed is:

1. An open loop resonator filter using apertures on the ground plane of a dielectric substrate, the open loop resonator filter comprising:
one or more open loop resonators formed on a upper side of the dielectric substrate and implemented by microstrip lines; and
one or more apertures formed on a predetermined area of the ground plane.

2. The open loop resonator filter as recited in claim 1, wherein each of the resonators has two open loops.

3. The open loop resonator filter as recited in claim 1, wherein the aperture is formed on predetermined portions of the ground plane, wherein the predetermined portion is a downwardly projected position from a position of an upper side where a gap coupling of two resonators occurred.
